(19) United States
(12) Patent Application Publication
(10) Pub. No.: US 2003/0081015 A1
(43) Pub. Date: May 1, 2003

(54) Personal digital assistant command bar method

(75) Inventors: Leonard J. Genest, Santa Ana, CA (US); Manouchehr Rahimzadeh, El Toro, CA (US)

Correspondence Address: Derrick Michael Reid, Esq., Attorney at Law, 26 La Costa Court, Laguna Beach, CA, 92651, US

(73) Assignee: Genovation Inc., Irvine, CA

(21) Appl. No.: 09/999,538

(22) Filed: Oct. 31, 2001

(51) Int. Cl. G09G 5/00

(52) U.S. Cl. 345/864

(57) ABSTRACT

A method of launching computer commands and programs on a personal digital assistance (PDA) includes sticking a molded membrane having elevated portions serving as emulated mechanical buttons over a touch sensitive screen that is in part disposed over a display with the mechanical buttons placed juxtaposed respective virtual buttons shown on the display, so that, upon pressing a portion of the membrane generates X-Y voltage levels corresponding to touch screen X-Y coordinates that are in turn associated with virtual button corresponding to computer commands and programs that are launched. The pressing of the emulated mechanical button offers stylus-free operation of the PDA.

### REFERENCE TO RELATED APPLICATION

(2) The present application is related to applicant's copending application entitled Personal Digital Assistant Command Bar Ser. No.: ______, filed yy/yy/yy, by the same inventors.

The present application is related to applicant's copending application entitled Personal Digital Assistant Command Bar Method Ser. No.: ______, filed yy/yy/yy, by the same inventors.

### FIELD OF THE INVENTION

The invention relates to the field of personal digital assistant hand held computers. More particularly the present invention relates to improved control panel controls for operating a personal digital assistant.

### BACKGROUND OF THE INVENTION

The personal digital assistant (PDA) has become commonly used for some time to provide users with mobile functions such as scheduling, addresses, recording messages and storing data. Data is typically entered into a PDA via a sensitive touch screen that is usually acted upon by pressure applied by a hand held stylus. The touch screen is a transparent pressure sensitive film that is disposed over a liquid crystal display (LCD). This LCD display displays data, virtual buttons, such as DONE, NEW, and DETAILS in addition to other virtual commands selections such as menus, check boxes and user pick lists. The touch screen is pressure sensitive so as to provide X and Y coordinate voltage levels that are associated with and respectively translated to the various virtual buttons on the LCD. The PDA may also include a graffiti area below the LCD. The touch screen also extends over the graffiti area and over a printed film in the graffiti area. The printed film shows graffiti buttons in printed form. The graffiti area has graffiti buttons such as those designated as APPLICATIONS, MENUS, CALCULATE and FIND graffiti buttons. When application programs are launched and executed on the PDA, command and control buttons are selected on the LCD or in graffiti area by touching the stylus onto the LCD or graffiti area at the appropriate location of the LCD virtual buttons or the graffiti buttons shown under the touch screen. The PDA may further include an attachable keyboard with mechanically actuated alpha numeric keys aligned for example as in a standard computer keyboard so as to enable conventional typing for entering alpha numeric characters. The PDA may also have a connector for the bi-directional transfer of data between the PDA and a stationary personal computer.

The PDA can receive alphanumeric characters from the attached mechanical keyboard. The PDA can be used to enter alphanumeric characters from a virtual keyboard display on the LCD. Alphanumeric characters that are entered using the stylus and pressing upon alphanumeric virtual buttons of a small virtual keyboard that displays on the LCD. The PDA can also enter alphanumeric characters through character recognition by hand scribing characters using the stylus typically onto the touch screen over the graffiti area. Some PDA software allows scribing data anywhere on the touch screen including area over the LCD with the stylus, as well as scribing data on the touch screen over the graffiti area.

Using the stylus, hand written alpha numeric characters can be written onto the touch screen over the graffiti area. These hand-scribed characters may be concurrently displayed on the LCD. These hand-scribed characters are typically referred to as graffiti and are subject to character recognition. With the advent of numerous keyboards entering the market for alphanumeric data entry for PDAs, the use of the stylus for commands and controls entry become awkward. Stylus commands are often required while typing on the attached keyboard. Holding the stylus while typing leads to awkward handling of keyboard and stylus often leading to the inadvertent loss of the stylus.

Certain computers and automatic teller machines have code buttons that are linearly aligned buttons juxtapose monitor segmented displays that corresponds to desired functions. When a code button is pressed, a computer code is generated. The computer code is associated with segmented display and translated to the desired function. The number of buttons limits the number of desired functions. The display monitors are heavy and are inconvenient for hand held use.

Most computers use mechanical mice electrically connected to the computers to move on-screen displayed cursors towards and upon displayed icons for launching various installed corresponding applications or command routines. However, a mechanical mouse is inconvenient to carry with a PDA. These and other disadvantages are solved or reduced using the invention.

### SUMMARY OF THE INVENTION

An object of the invention is to provide a mechanical means for selecting liquid crystal display (LCD) virtual buttons.

Another object of the invention is to provide a mechanical means for selecting liquid crystal display (LCD) virtual buttons overlaid with a touch screen.

Another object of the invention is to provide a mechanical means for selecting liquid crystal display (LCD) virtual buttons of a personal digital assistant (PDA).

Yet another object of the invention is to provide a mouse means for selecting computer functions in a PDA.

Yet a further object of the invention is to provide a computer mouse means for selecting computer functions in a PDA using mechanical buttons in a graffiti area overlaid with a touch screen.

Still another object of the invention is to provide a method for selecting virtual buttons of an LCD in a PDA.

Still another object of the invention is to provide mechanical means for selecting graffiti button in a graffiti area of a PDA

Still a further object of the invention is to provide mechanical means for selecting graffiti buttons in a graffiti area overlaid with a touch screen.

The invention is directed to an improved PDA with mechanical buttons over a touch sensitive screen to enable secure finger selection of computer functions. In a first aspect of the invention, a small stick-on printed membrane or rubber-molded panel is affixed to the PDA onto a touch screen overlaying a graffiti area for emulating a computer mouse function. In a second aspect of the invention, a method is used for creating mechanical buttons over a touch sensitive screen. In a third aspect of the invention, means are used for creating mechanical buttons in association with displayed virtual buttons or icons.

The mechanical buttons are preferably formed by a stick-on panel membrane affixed to a touch screen and having top surfaces elevated above touch screen for enabling rapid finger touch and pressing. The mechanical buttons are pressed to manipulate a cursor displayed on the LCD of the PDA, and for activating virtual buttons displayed on the LCD. The cursor may be displayed on an LCD of a PDA for selecting virtual button displayed on the LCD. To emulate the mouse function, the stick-on panel membrane includes a cursor button and a mouse activation button cooperatively functioning as an emulated mouse. The cursor button is preferably a large oval indented cursor button. The mouse activation button is preferably a small round or oval button. The cursor button and mouse activation button emulate a conventional computer mechanical mouse function in association with the cursor displayed on the LCD. Additional mechanical buttons may also be used for activating conventional or new command and control functions.

The stick-on panel may for example include standard graffiti buttons such as APPLICATIONS, MENUS, CALCULATE and FIND located in the graffiti area. The graffiti area is preferably used exclusive for placement of graffiti buttons. Alpha numeric characters can be entered preferably by an attached keyboard. The attached keyboard enables rapid typing for user convenience.

The stick-on printed membrane is preferably a rubber-molded panel that is bonded to a touch screen extending over the LCD and graffiti area. The rubber-molded panel preferably includes the standard graffiti buttons as well as the mouse activation button and cursor button. The cursor button and mouse button are disposed in a mouse area in the center of the graffiti area. The buttons are all raised buttons for easy touch feel by the user. The cursor button is preferably indented with a concave top so that a finger may be placed in the indentation for simulated rocker control of the on-screen LCD displayed cursor that is moved on the LCD by applying pressure to the cursor button in the various directions of preferred travel of the displayed cursor. The mouse activation button may be placed next to the cursor direction button that when pressed will cause the activation of a virtual button or icon displayed on the LCD where the cursor is positioned. A software driver in the PDA is used with the stick-on panel so as to reassign the standard graffiti buttons into zones for respective association with mechanical buttons emulated by the stick-on panel. The software driver also enables mouse cursor control and mouse activation functions. When a graffiti membrane button is pressed by pressing a raised elevated portion of the stick-on panel, the touch screen X-Y coordinate voltage levels are generated and translated into a corresponding function, such as the mouse activation or cursor movement, as well as standard functions including APPLICATION, MENUS, CALCULATE and FIND. The stick-on panel mechanical cursor button overlays corresponding pressure sensitive locations for generating respective X-Y coordinate voltages levels that response to pressure under the mechanical buttons. In the case of the cursor button, corresponding directional control is enabled by pressing the oval cursor button at a radial position so as to cause an on-screen LCD cursor to move in a corresponding direction. The cursor button may be preferably used to generate voltage levels corresponding to a plurality of radial directions, such as four or eight or more radial directions. The oval shaped cursor button can be replaced with a plurality of individual directional cursor buttons serving the same function, such as four or eight or more individual directional cursor buttons. The mouse activation button is preferably disposed next or alternatively centered within the cursor button. The mouse activation button is used to activate a virtual button function for launching a corresponding command when the on-screen LCD cursor is moved over a desired virtual button displayed on the LCD. Pressing the mouse activation mechanical button will activate the selected virtual button command as an emulated mechanical mouse operation for emulating a manual stylus selection. The graffiti area with the overlaid stick-on mechanical membrane provides mechanical graffiti buttons subject to easier user manipulation and may retain the standard graffiti button as well as providing an effective mouse control all within the visible graffiti area.

The stick-on molded panel may further include a command bar disposed within the graffiti area to activate one or more virtual buttons displayed on the LCD. The virtual buttons may include for example, DONE, NEW, and DETAILS virtual buttons. The command bar is effectively segmented into a plurality of mechanical buttons, such as three mechanical buttons, depending where pressure is applied along the length of command bar. The command bar is typically located at the top of the graffiti area and below the LCD and juxtaposed the virtual buttons.

The mechanical buttons may be in the form of a command bar or control bars are disposed over and onto a touch screen for generating X and Y coordinate voltage levels. The touch screen may be disposed over both the graffiti area and the LCD. The mechanical buttons of the command bar or and control bars are disposed juxtapose displayed virtual buttons for visual association between the mechanical buttons and the virtual buttons. A virtual button is a displayed icon upon which may be disposed a touch sensitive screen for activation. In a preferred form, one of more control bars are disposed along the edges of the touch sensitive screen overlaying an LCD displaying a plurality of virtual buttons in juxtapose association with mechanical buttons that are linearly aligned as the control bar. The control bar like the command bar is a raised elevated portion of a stick-on membrane is effectively segmented into a plurality of mechanical buttons. A control bars is a stick-on membrane or a molded rubber panel that when pressed on a raised elevated portion provides X-Y voltage levels corresponding to X-Y coordinates that are translated into the virtual buttons that are associatively displayed juxtaposed the control bar. When pressing the control bar at a particular location, screen X-Y coordinate voltage levels of the touch sensitive screen under the control bars are used to select respective juxtapose virtual on-screen virtual buttons so as to actuate the virtual buttons. The PDAs may have one or more control bars that preferably linearly extend over the touch screen and may extend over the LCD as desired for configuring a mechanical button layout formed by control bars. On-screen controls and commands are actuated by pressing the control bars at particular locations emulating particular mechanical buttons corresponding to respective on-screen virtual buttons that are typically displayed along the edges of the visible LCD. The on-screen displays can be touch sensitive virtual buttons when the virtual button icon are displayed under a portion of the touch sensitive screen. Alternatively, virtual button can be merely a displayed icons that is covered by a protective covering rendering the virtual button insensitive to mechanical pressure as merely a displayed icon, so as to prevent inadvertent activation of the virtual buttons then relying solely upon the mechanical buttons of the control bars disposed over a non-visible portion of the touch screen. A control bar may be placed for example along the bottom edge of the LCD and over a portion of the LCD and corresponding portion of the touch screen for selecting exemplar virtual buttons such as DONE, NEW and DETAILS. A control bar may also be optionally extended along the two left and right sides and the top edges of the LCD so as to enable customized applications and mechanical button layouts to be designed for use with fast acting finger presses that rapidly select commands or controls by pressing the control bars at respective points next to the associated virtual buttons or displayed icon. The use of the various control bars for perfecting a desired combination of mechanical buttons over the touch screen as well as displaying unique combination of virtual buttons or displayed icons offer improved flexibility in configuring a control panel for the PDA. The combination of mouse emulation function and manually actuated command bar and control bars provides stylus free selection of PDA commands and controls. The mechanical buttons, command bar and control bars provide fast access to frequently used commands and controls. An attachable mechanical keyboard allows for the entry of alphanumeric characters. These and other advantages will become more apparent from the following detailed description of the preferred embodiment.

### BRIEF DESCRIPTION OF THE DRAWINGS

FIG. 1 is a personal digital assistant (PDA) having a single command bar over a portion of a touch screen and an indented mechanical cursor button in a graffiti area.

FIG. 2 is a PDA having a plurality of control bars over respective portions of the touch screen with juxtaposed virtual buttons displayed on a liquid crystal display and with four cursor buttons in the graffiti area.

FIG. 3 is a PDA command launching method flow diagram.

### DETAILED DESCRIPTION OF THE PREFERRED EMBODIMENT

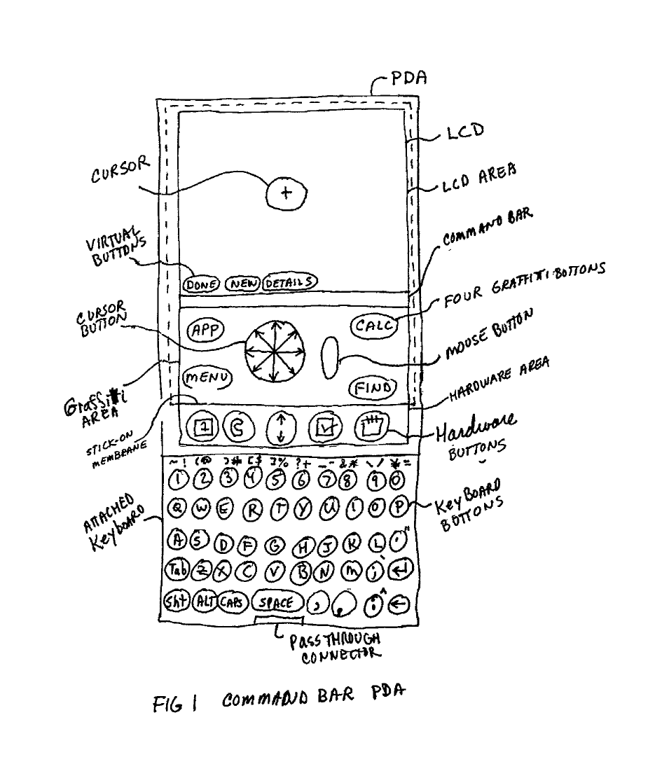

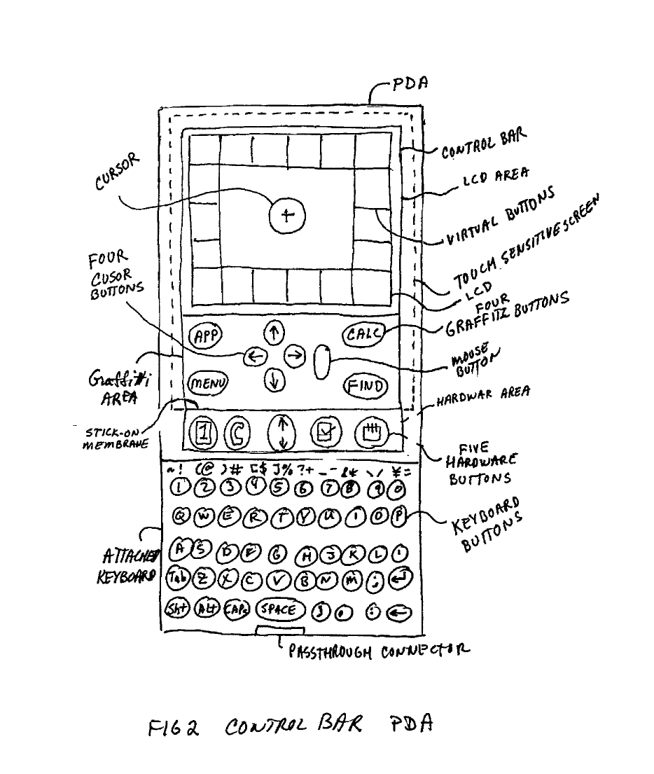

An embodiment of the invention is described with reference to the figures using reference designations as shown in the figures. Referring to FIGS. 1 and 2, a personal digital assistant (PDA) includes liquid crystal display (LCD) area, a graffiti area, a hardware area, and an attachable keyboard. An LCD is dispose in the LCD area. A touch sensitive screen is disposed over the LCD area, graffiti area and hardware area. The touch sensitive screen is a transparent electronic screen that provides X-Y coordinate voltage levels in response to pressure exerted by a finger of a human being. The LCD displays virtual buttons that may be by way of example conventional software virtual buttons, such as DONE, NEW, and DETAILS. A stick-on mechanical membrane is disposed LCD over graffiti area and hardware area for providing graffiti buttons such as APPLICATION, MENU, CALCULATE and FIND graffiti buttons. The PDA may further include conventional mechanical hardware buttons such as exemplar mechanical hardware buttons MODEM, PHONE, SYSTEM CHECK and PRINTER hardware buttons. The mechanical membrane also provides for a graffiti area mouse button, cursor buttons, and a command bar. The cursor buttons function to move the cursor displayed on the LCD over desired virtual buttons and are activated when pressing the mouse button when the displayed cursor is over the desired virtual button. The cursor button can be one indented directional button as shown in FIG. 1 or a plurality of directional buttons as shown in FIG. 2. The command bar extends the width of graffiti area and is in operational association with virtual buttons, such as DONE, NEW and Details, as shown in FIG. 1. Instead of a command bar disposed in the graffiti area, the membrane can be adapted to lay around and over an edge portion of the LCD area and touch sensitive screen, a control bar that linearly extends around the four edges of the LCD area for operational association with the plurality of aligned displayed virtual buttons, as shown in FIG. 2. The command bar and control bar are mechanical buttons for selecting associated juxtaposed virtual buttons displayed on the LCD. The attachable keyboard has conventional keyboard mechanical buttons. The attachable keyboard may further have a pass through connector for communicating data between the PDA and a personal computer, not shown.

The mechanical stick-on membrane is preferably a thin printed rubber overlay that is placed over the entire graffiti area and is designed to be used with the fingertip for stylus-free operation. The membrane may also cover part of the touch screen over the LCD for close association of the virtual buttons and respective portion of the control bar. The membrane can have various shaped raised portions. For examples, the indented directional cursor button may take various shapes, such as a concaved dish, or raised ring, along the edge of which is a portion of the cursor button that is pressed to move the displayed cursor in the desired direction of cursor travel over the LCD and onto desired virtual buttons or displayed icons, check boxes or list. The buttons can be square, round, oval or any desired shaped and can be disposed in various arrangements. In the preferred form, the standard PDA graffiti buttons are shown in standard placement for user convenience, but any variety of shapes and placement of buttons and bars can be used as desired to provide any membrane button configuration.

The four graffiti buttons are preferably standard PDA graffiti buttons, APPLICATIONS, MENU, CALCULATE and FIND, but also include the cursor button and mouse button for emulating a computer mouse function. The overlaid mechanical membrane enables the manual stylus-free finger selection of the standard, mouse and cursor graffiti buttons. The command bar is preferably a raised linearly extending bar that is placed over the top edge of the graffiti area below and in association with the standard DONE, NEW, and DETAILS virtual buttons displayed on the LCD. The command bar has respective portions that when pressed activates the associated virtual buttons by pressing the command bar next to the virtual button to be actuated. The command bar allows activation of the command associated with the virtual button using a fingertip.

The command bar may provide selection of only a few virtual buttons among many virtual buttons that can be displayed. The command bar preferably is associated with virtual buttons immediately next to respective portions of the command bar. The display cursor is preferably a blinking mouse cursor for selecting any of the virtual buttons displayed on the LCD. The display cursor is moved and activated respectively using the cursor buttons and mouse button disposed in the graffiti area. The cursor buttons and mouse button are part of the stick-on overlay in the graffiti area. When an edge portion of the indented cursor button or one of directional cursor buttons is pressed, the on-screen blinking cursor displayed in the LCD will move in the same corresponding direction. The mouse button is a command activation button that is preferably placed to the right of the cursor buttons. When the mouse activation button is pressed when the displayed cursor is positioned on a displayed virtual button, check box, or list item, the virtual button command is activated and the corresponding program is launched or the item selected to perfect the command. The cursor button, mouse button and displayed cursor combine to emulate a computer mouse function.

Pressing any of the mechanical buttons on the overlay membrane applies pressure to the touch sensitive screen in the graffiti area, hardware area or LCD area. Software drivers are used to translate the X-Y coordinate voltage levels into inputs corresponding to assigned associated buttons. Software drivers can translate X-Y voltage levels from the touch sensitive screen into X-Y coordinates of the touch sensitive screen. The X-Y coordinates are then associated with respective commands associated with the software drivers. Software drivers are well known by those skilled in the art of computer programming. The software driver analyses the X-Y coordinate voltage levels resulting from pressure on the touch sensitive screen and performs the associated function of launching or selecting the associated command or item.

The software driver will also display the mouse cursor on the LCD and move the displayed cursor around the LCD as controlled by the mouse cursor button in the direction of pressure applied to the cursor button that may have cross hairs indicating up, down, left and right directions. When the top edge of the cursor button is pressed, software driver causes the displayed cursor to move up in the LCD. The cursor button or buttons can be divided into any number of equiangular directional controls for example, four direction 90° apart, eight directions 45° apart, sixteen directions 22.5° apart. The software driver may further average cursor controls such as when a four directional cursor button in pressed between two orthogonal direction, for example, up-left, causing a 45° angular move of the cursor, even though the cursor button has only four buttons. When the displayed cursor is positioned over or on any on-screen LCD area or virtual button, the cursor button is then released, and the cursor will remain in the current position. Then, when the mouse activation button is pressed, a program may be launched corresponding to the virtual button of item upon which the displayed cursor is moved. The combination of the cursor and mouse button for moving and activating the displayed cursor is used for stylus-free mouse operation including highlighting text, selecting functions, launching commands.

The command bar that extends along the edge of the LCD can be extended to extend along the sides and top edges of the display LCD as a continuous control bar. The control bar is shown as only linearly extending along the edges, but the control bar can be curved and placed upon the LCD. The control bar disposed on the side is disposed over the touch sensitive screen and may also be over a portion of the LCD screen, that is, a side portion of the LCD may be obscured by the membrane. Transparent membranes could be used to provide elevated buttons for finger touch as well as displaying virtual buttons under the membrane. In the preferred form, the LCD displays virtual buttons in juxtapose association with respective portions of the control bar for providing emulated mechanical buttons for user convenience. The layout of the control bars, command bars, graffiti buttons, and hardware buttons, as well as the underlying software programs for perfecting commands can be adapted for particular applications. The PDA application software can be designed in a variety of the button layout configurations. The PDA can also have a protective covering for use in rugged environments where it is desirous of using the PDA with mechanical buttons. The PDA can be efficiently used to enter data in hostile environments.

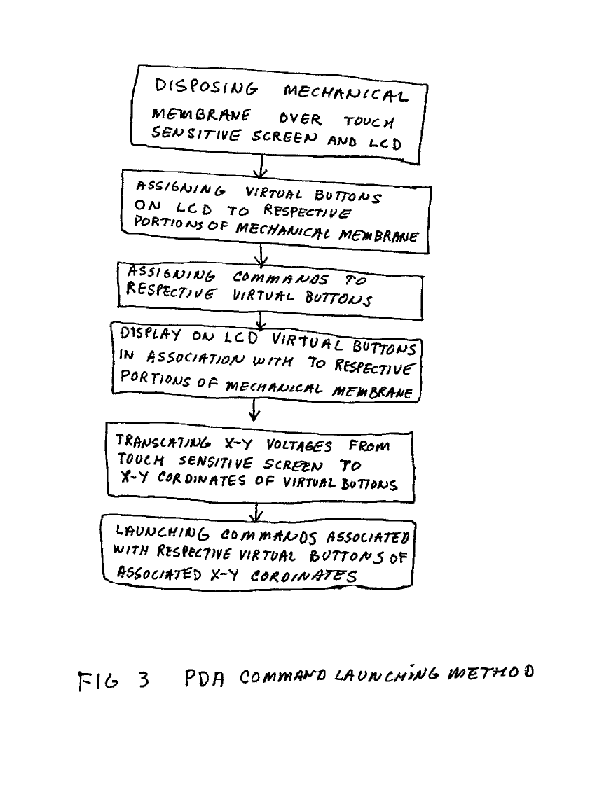

Referring to all of the Figures, and more particularly to FIG. 3, the method of launching a PDA command is based upon placing a membrane having elevated portions over the touch sensitive screen making the membrane function as emulated mechanical buttons. The membrane can be placed over portions of the LCD as well, as typically, the PDA is made with the touch sensitive screen disposed over the LCD. Hence, the membrane can be a stick-on membrane adapted to fit over existing PDA configurations. In the case of a command bar or control bar, the membrane is placed juxtapose virtual buttons that are displayed on the LCD and hence, portions of the membrane are associated with the virtual buttons. Computer commands and programs are assigned to virtual buttons as is conventional practice. The virtual buttons are displayed on the LCD in associated placement with the control bar or command bar. When a finger is pressed upon a portion of the control bar or command bar, X-Y voltage levels from the touch sensitive screen are generated. The X-Y voltage levels are translated by the software driver to X-Y coordinates of the touch sensitive screen. The X-Y coordinates are then translated to the associated virtual button. The software driver then launches the computer program or command associated with the virtual button, that is associated with touch screen X-Y coordinates that are in turn associated with portions of the command bar or control bar of the stick-on membrane. It this way, the membrane serves as an emulated mechanical button for operating the PDA. In the case of the graffiti buttons and hardware keys, the membrane may completely cover these areas, and as such, the LCD need not extend into the graffiti area or hardware area. The membrane can be formed in a variety of configurations for configuring the button layout of the PDA. Those skilled in the art can make enhancements, improvements, and modifications to the invention, and these enhancements, improvements, and modifications may nonetheless fall within the spirit and scope of the following claims.

What is claimed is:

1. A method of launching commands in a personal digital assistant, (PDA) having a programmed processor, the method comprising the steps of,
disposing a membrane over a touch screen,
assigning virtual buttons to respective portions of the membrane,
displaying the virtual bottoms in association with the respective display portions of the membrane, and
translation X-Y voltages from the touch screen into X-Y coordinates associated with the virtual buttons for launching commands associated with the virtual buttons.

2. The method of claim 1 further comprising the step of,
aligning the virtual buttons with the membrane linearly disposed along the aligned virtual buttons, the membrane forming a control bar, the respective portions being elevated portions above the virtual buttons.

3. The method of claim 1 wherein the disposing step, the membrane is a stick-on membrane that is bonded to touch screen.

4. The method of claim 1 wherein,
the touch screen extends over a graffiti area,
the membrane extends over the graffiti area having graffiti portions as mechanical graffiti buttons, and
the translation steps further translates X-Y voltages from the touch screen into X-Y coordinates associated with the graffiti buttons for launching commands associated with the graffiti buttons.

5. The method of claim 1 wherein,
the touch screen extends over a hardware area,
the membrane extends over the hardware area having hardware portions as mechanical hardware buttons, and
the translation steps further translates X-Y voltages from the touch screen into X-Y coordinates associated with the hardware buttons for launching commands associated with the hardware buttons.
